(19) United States
(12) Patent Application Publication
(10) Pub. No.: US 2024/0329462 A1
(43) Pub. Date: Oct. 3, 2024

(54) SPACE PHASE MODULATOR, PROCESSING APPARATUS, AND INFORMATION PROCESSOR

(71) Applicant: SONY GROUP CORPORATION, TOKYO (JP)

(72) Inventor: YOSHITOMO ISOMAE, TOKYO (JP)

(21) Appl. No.: 18/578,023

(22) PCT Filed: Mar. 16, 2022
(86) PCT No.: PCT/JP2022/011841

§ 371 Date: Jan. 10, 2024

(30) Foreign Application Priority Data
Jul. 28, 2021 (JP) 2021-123676

(51) Int. Cl. G02F 1/1337; G02F 1/137

(52) U.S. Cl. CPC G02F 1/133707; G02F 1/133761; G02F 1/13712

(57) ABSTRACT

A space phase modulator according to one embodiment of the present disclosure is a modulator that modulates a phase of light to generate a desired image. The space phase modulator includes a stacked body in which a plurality of pixel electrodes, a first alignment film, a liquid crystal layer, a second alignment film, and a common electrode are stacked in this order. The liquid crystal layer has liquid crystal molecules having negative dielectric anisotropy. The first alignment film and the second alignment film are configured to allow a pretilt angle θt0 of the liquid crystal molecules to satisfy 0°<θt0≤80°.

### TECHNICAL FIELD

The present disclosure relates to a space phase modulator, a processing apparatus, and an information processor.

### BACKGROUND ART

A space phase modulator that modulates a phase of light to generate a desired image is able to control light interference. Therefore, the space phase modulator is expected to have a wide range of applications including stereoscopic display or laser processing. The space phase modulator has a panel structure having a liquid crystal layer interposed between electrodes, and is able to control a phase of entering light in an analog manner, by controlling a voltage applied to the liquid crystal layer.

### CITATION LIST

### Patent Literature

PTL 1: Japanese Unexamined Patent Application Publication No. 2000/171824

PTL 2: Japanese Unexamined Patent Application Publication No. 2020-109490

### SUMMARY OF THE INVENTION

To modulate only a phase of light, it is important that liquid crystal molecules tilt only in a polar angle direction with respect to pixel electrodes when a voltage is applied. In a case where the liquid crystal molecules rotate in an azimuth direction with respect to the pixel electrodes, a polarized state of light entering a space phase modulator (entering light) changes, and light outputted from the space phase modulator (outputted light) is in a polarized state different from the polarized state of the entering light. As a result, light that does not contribute to interference as the outputted light is generated, thus reducing utilization efficiency of light. Hence, it is desirable to provide a space phase modulator that is able to improve the utilization efficiency of light, and a processing apparatus and an information processor that each include the space phase modulator.

A space phase modulator according to an embodiment of the present disclosure is a modulator that modulates a phase of light to generate a desired image. The space phase modulator includes a stacked body in which a plurality of pixel electrodes, a first alignment film, a liquid crystal layer, a second alignment film, and a common electrode are stacked in this order. The liquid crystal layer has liquid crystal molecules having a negative dielectric anisotropy. The first alignment film and the second alignment film are configured to allow a pretilt angle θt0 of the liquid crystal molecules to satisfy 0°<θt0≤80°.

A processing apparatus according to an embodiment of the present disclosure is an apparatus using a space phase modulator that modulates a phase of light to generate a desired image. In the processing apparatus, the space phase modulator has a configuration similar to the space phase modulator described above.

An information processor according to an embodiment is an apparatus using one or more space phase modulators that each modulate a phase of light to generate a desired image. In the information processor, the space phase modulator has a configuration similar to the space phase modulator described above.

In the space phase modulator, the processing apparatus, and the information processor according to the respective embodiments of the present disclosure, the first alignment film and the second alignment film are configured to allow the pretilt angle θt0 of the liquid crystal molecules to satisfy 0°<θt0≤80°. This suppresses rotation of the liquid crystal molecules in the azimuth direction.

### BRIEF DESCRIPTION OF DRAWING

FIG. 1A is a diagram describing reverse tilt. FIG. 1(B) is a diagram describing interaction between curvature of equipotential lines and elastic force of a liquid crystal layer.

FIG. 2 is diagram illustrating an example of a cross-sectional configuration of a space phase modulator according to one embodiment of the present disclosure.

FIG. 3 is a diagram illustrating an example of planar configuration of the space phase modulator of FIG. 2.

FIG. 4(A) is an enlarged diagram illustrating the liquid crystal molecule of FIG. 2 and FIG. 3. FIG. 4(B) is an enlarged diagram of the liquid crystal molecule in which rotation in an azimuth direction occurs.

FIG. 5 is a diagram illustrating a modification example of a cross-sectional configuration of the space phase modulator of FIG. 1.

FIG. 6 is a diagram illustrating a modification example of the cross-sectional configuration of the space phase modulator of FIG. 1.

FIG. 7 is a diagram illustrating a modification example of the cross-sectional configuration of the space phase modulator of FIG. 1.

FIG. 8 is an enlarged diagram illustrating a liquid crystal molecule when an electric field is applied.

FIG. 9 is a diagram illustrating an example of a relationship of a voltage difference between two pixels and the rotation in the azimuth direction.

FIG. 10 is a diagram illustrating an example of a relationship between a liquid crystal material and an angle necessary for suppressing reverse tilt.

FIG. 11 is a diagram illustrating an example of a relationship between a thickness of the liquid crystal layer and the angle necessary for suppressing the reverse tilt.

FIG. 12 is a diagram illustrating an example of action of the space phase modulator of FIG. 1.

FIG. 13 is a diagram illustrating an example of action of the space phase modulator of FIG. 1.

FIG. 14 is a diagram illustrating an example in which the space phase modulator of FIG. 1 is applied to a laser processing machine.

FIG. 15 is a diagram illustrating an example in which the space phase modulator of FIG. 1 is applied to optical computing.

FIG. 16 is a block diagram depicting an example of schematic configuration of a vehicle control system.

FIG. 17 is a diagram of assistance in explaining an example of installation positions of an outside-vehicle information detecting section and an imaging section.

### MODES FOR CARRYING OUT THE INVENTION

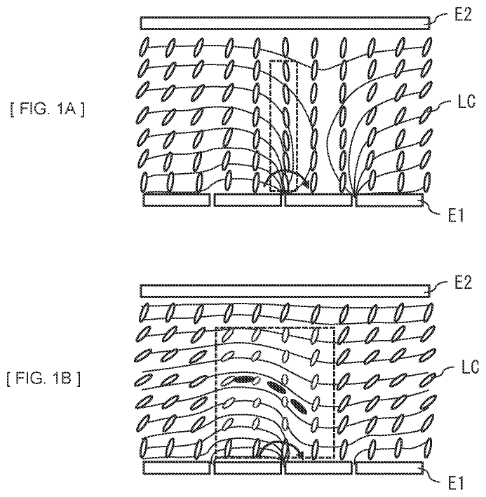

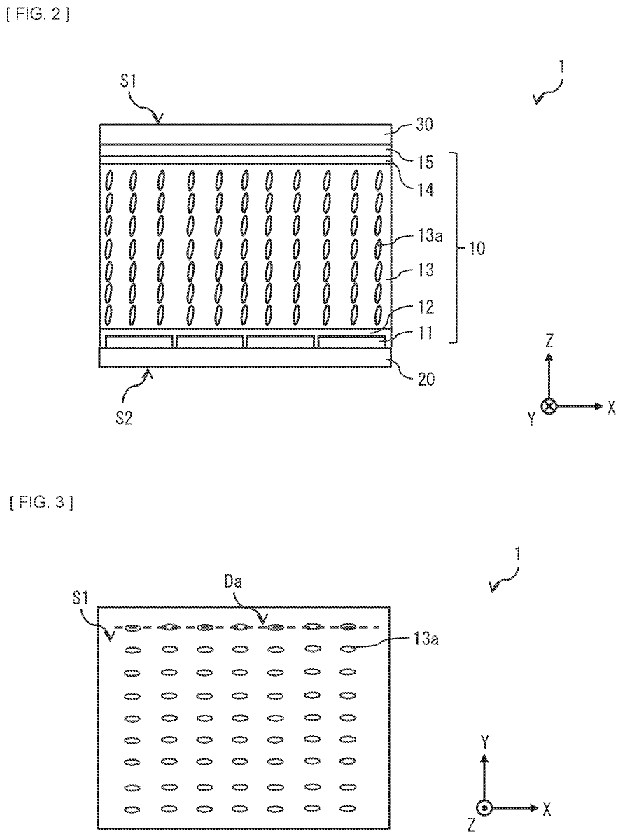

In the following, some embodiments of the present disclosure will be described in detail with reference to the drawings. It is to be noted that the description will be given in the following order.
1. Background (FIG. 1(A) and FIG. 1(B))
2. Embodiments (FIG. 2 to FIG. 13)
3. Application Examples (FIG. 14 to FIG. 17)

### <1. Background>

A space phase modulator that modulates a phase of light to generate a desired image is able to control light interference. Therefore, the space phase modulator is expected to have a wide range of applications including stereoscopic display or laser processing. The space phase modulator has a panel structure having a liquid crystal layer interposed between electrodes, and is able to control a phase of entering light in an analog manner, by controlling a voltage applied to the liquid crystal layer. To modulate only the phase of light, it is important that liquid crystal molecules tilt only in a polar angle direction with respect to pixel electrodes when a voltage is applied. In a case where the liquid crystal molecules rotate in an azimuth direction with respect to the pixel electrodes, a polarized state of light entering the space phase modulator (entering light) changes, and light outputted from the space phase modulator (outputted light) is in a polarized state different from the polarized state of the entering light. As a result, light that does not contribute to the interference as the outputted light is generated, thus reducing utilization efficiency of light.

In a case where liquid crystal molecules having a positive dielectric anisotropy are used in the space phaser modulator, it is inevitable as a principle that a fringe electric field in a direction orthogonal to an alignment direction of the liquid crystal molecules causes rotation of the liquid crystal molecules in the azimuth direction. On the other hand, alignment of the liquid crystal molecules having a negative dielectric anisotropy has not been elucidated. As such, as a result of making an analysis of the alignment of the liquid crystal molecules having the negative dielectric anisotropy using a prototype device, the inventor of the present application could confirm that the rotation also occurred in the azimuth direction in the liquid crystal molecules having the negative dielectric anisotropy.

As a result of consideration of the principle that causes the rotation of the liquid crystal molecules having the negative dielectric anisotropy in the azimuth direction, the inventor of the present application found the following two principles.

FIG. 1(A) is a diagram for describing Principle 1. FIG. 1(B) is a diagram for describing Principle 2. In FIG. 1(A) and FIG. 1(B), LC represents a liquid crystal, E1 represents a pixel electrode, and E2 represents a common electrode. A solid line represents an equipotential line, and an arrow a fringe electric field. In FIG. 1(A), a part surrounded by a dashed line depicts a part where the rotation in the azimuth direction occurs in the liquid crystals LC according to “Principle 1”, when a relatively small voltage difference is applied between the pixel electrode E1 and the common electrode E2. In FIG. 1(B), a part surrounded by the dashed line depicts a part where the rotation in the azimuth direction in the liquid crystals LC occurs according to “Principle 2” when a relatively large voltage difference is applied between the pixel electrode E1 and the common electrode E2.

### (Principle 1)

### Reverse Tilt Caused by Fringe Electric Field

In the liquid crystal layer, it is desirable that an electric line of force occur vertically from the pixel electrodes E1 toward the common electrode E2. Between the two pixel electrodes E1 to which significantly different voltages are applied, however, the electric line of force (arrow in FIG. 1(A)) occurs from the one pixel electrode E1 to another pixel electrode E2. In a case where an electric field corresponding to this electric line of force provides the liquid crystal molecules LC with a force to reverse pretilt, the liquid crystal molecules LC rotate in a reverse direction to the pretilt, causing reverse tilt. This force acts as a force causing the liquid crystal molecules LC to rotate 180° in the azimuth direction. Furthermore, influenced by the liquid crystal molecules LC where the reverse tilt has occurred, the surrounding liquid crystal molecules LC also rotate in the azimuth direction due to an elastic force of the liquid crystal layer (part surrounded by the dashed line in FIG. 1(A)).

### (Principle 2)

Interaction between Curvature of Equipotential Line and Elastic Force of Liquid Crystal Layer

In a case where mutually different voltages are applied to the two mutually adjacent pixel electrodes E1 and E2, the equipotential lines in the liquid crystal layer are curved. At this time, if it is assumed that the rotation in the azimuth direction of the liquid crystal molecules LC is 0, the liquid crystal molecules LC having the negative dielectric anisotropy should rotate so that under the force of the electric field, long axes of the liquid crystal molecules LC are parallel to the equipotential lines (black liquid electric molecules in FIG. 1(B)). However, because the equipotential lines are curved, the liquid crystal molecules LC are in a bend alignment state and in a state having a high elastic force (part surrounded by the dashed line in FIG. 1(B)). At this time, elastic energy becomes the lowest when the liquid crystal molecules rotate 90° in the azimuth direction. Therefore, the curved electric field acts as a force that causes the liquid crystal molecules to rotate 90° in the azimuth direction, and the liquid crystal molecules are rotated 90° in the azimuth direction due to the curved electric field (part surrounded by the dashed line of FIG. 1(B)).

In light of the two principles described above, the inventor of the present application has considered approaches to suppress the rotation of the liquid crystal molecules in the azimuth direction by increasing free energy when the liquid crystal molecules rotate in the azimuth direction. Such a possible approach is to enhance anchoring strength of an alignment film. However, there are limitations to control of the anchoring strength of the alignment film, and improvement only by enhancing the anchoring force is not realistic.

The inventor of the present application has discovered through simulations or experiments that in some cases, the rotation in the azimuth direction caused by the curvature of the electric field may occur triggered by the reverse tilt. From this, the inventor of the present application has found that it is important to at least to prevent occurrence of the reverse tilt, in order to partially solve the issue of the rotation in the azimuth direction. As such, the inventor of the present application proposes the following invention that focuses on suppression of the reverse tilt.

### <2. Embodiments>

### [Configuration]

FIG. 2 illustrates an example of a cross-sectional configuration of a space phase modulator 1 according to one embodiment of the present disclosure. The space phase modulator 1 is an optical device that modulates a phase of light to generate a desired image. As illustrated in FIG. 2, for example, the space phase modulator 1 includes a stacked body 10 in which a plurality of pixel electrodes 11, an alignment film 12, a liquid crystal layer 13, an alignment film 14, and a common electrode 15 are stacked in this order. The space phase modulator 1 further includes a pair of glass substrates 20 and 30 that sandwich the stacked body 10, as illustrated in FIG. 2, for example.

The plurality of pixel electrodes 11 and the alignment film 12 are stacked on a surface of the glass substrate 20, and the common electrode 15 and the alignment film 14 are stacked on a surface of the glass substrate 30. The glass substrates 20 and 30 are opposed to each other with the plurality of pixel electrodes 11, the alignment films 12 and 14, and the common electrode 15 in between. The plurality of pixel electrodes 11 is two-dimensionally arranged on the surface of the glass substrate 20 with predetermined gaps in between. The pixel electrodes 11 have a size of, for example, several tens of um x several tens of um.

The liquid crystal layer 13 that is in contact with the alignment films 12 and 14 is formed between the alignment film 12 and the alignment film 14. The liquid crystal layer 13 includes liquid crystal molecules 13a having the negative dielectric anisotropy. Here, the “negative dielectric anisotropy” means that a liquid crystal molecule has a property that when an electric field is applied, a short axis of the liquid crystal molecule becomes parallel to a direction of the electric field. It is to be noted that the “positive dielectric anisotropy” means that the liquid crystal molecule has the property that when an electric field is applied, a long axis of the liquid crystal molecule becomes parallel to the direction of the electric field.

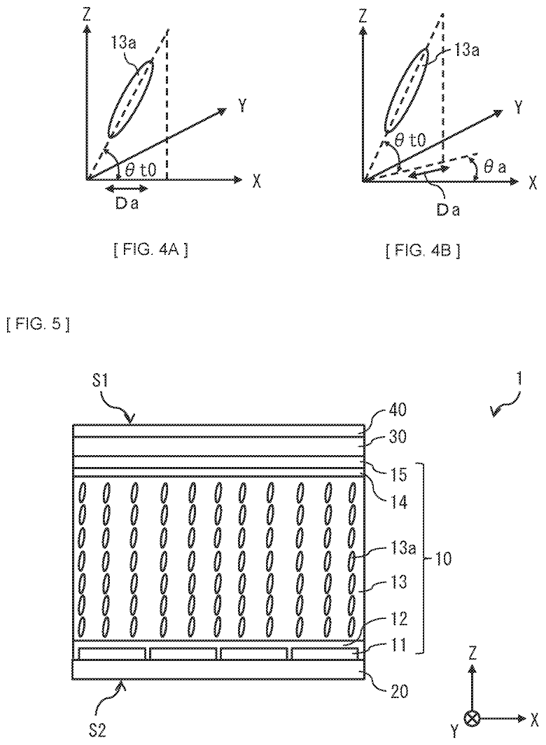

FIG. 3 illustrates an example of a planar configuration of the space phase modulator 1. In FIG. 3, the liquid crystal molecules 13a are projected onto the glass substrate 30. FIG. 4(A) illustrates an enlarged view of the liquid crystal molecule 13a to which no electric field is applied. The alignment films 12 and 14 regulate an alignment direction Da of the liquid crystal molecule 13a and a pretilt angle θt0, and are, for example, inorganic alignment films formed by oblique evaporation. The alignment direction Da refers to a long axis direction of a projected image when the liquid crystal molecule 13a is projected onto an XY plane (pixel electrode 11). The alignment direction Da is a direction parallel to X axis, for example. The pretilt angle θt0 refers to an angle (polar angle) made between the long axis of the liquid crystal molecule 13a and the XY plane (pixel electrode 11) when no voltage is applied between the pixel electrode 11 and the common electrode 15.

It is to be noted that for reference, FIG. 4(B) illustrates how the liquid crystal molecule 13a rotates in the azimuth direction when a voltage difference ΔV occurs between the two mutually adjacent pixel electrodes 11. In FIG. 4(B), a rotation angle θa represents a maximum rotation angle in the azimuth direction of the liquid crystal molecule 13a contained in a middle region in a thickness direction of the liquid crystal layer 13 when the voltage difference between the two mutually adjacent pixel electrodes 11 changes from 0 volts to ΔV volts. In a case where the rotation angle θa is zero, it means that the alignment direction Da does not change. Therefore, in this case, when linear polarized light having a polarization plane parallel to the alignment direction Da passes through the liquid crystal layer 13, the liquid crystal layer 13 has an action of modulating only a phase with respect to the passing linear polarized light without changing a polarized state.

In the space phase modulator 1, the alignment direction Da of the liquid crystal molecules 13a (strictly speaking, the alignment direction Da when the voltage difference between the two mutually adjacent pixel electrodes 11 is 0 volts) is parallel to the polarization plane of linear polarization light (entering light L1) that enters the space phase modulator 1. The alignment films 12 and 14 are configured to allow the pretilt angle θt0 of the liquid crystal molecules 13a to be equal to or less than a predetermined angle θth. A detailed description of the angle θth is given below.

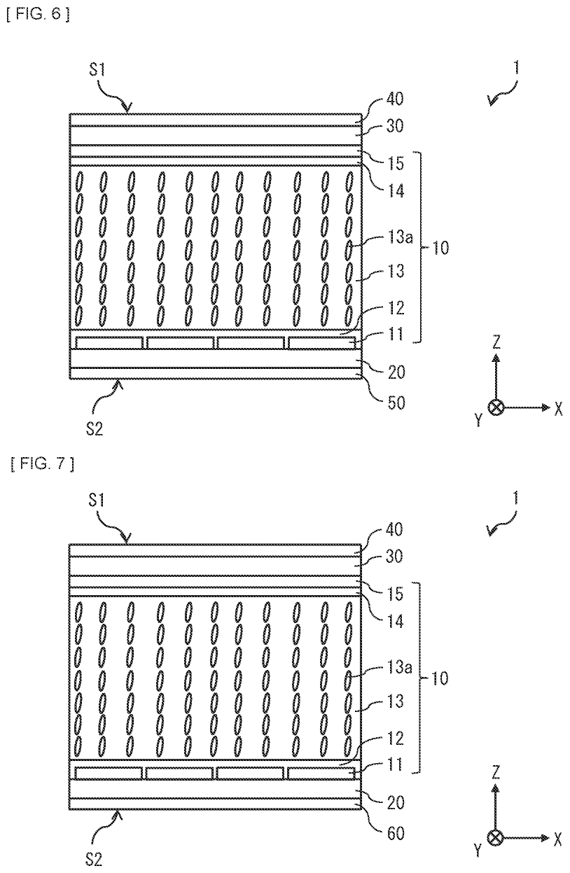

As illustrated in FIG. 5, for example, the space phase modulator 1 may further include a linear polarization plate 40 on the glass substrate 30. A polarizing axis (transmission axis) of the linear polarization plate 40 is parallel to the alignment direction Da of the liquid crystal molecules 13a. In a case where the space phase modulator 1 is a transmission-type modulator, the space phase modulator 1 may further include a linear polarization plate 50 on a rear surface of the glass substrate 20, as illustrated in FIG. 6, for example. The linear polarization plate 50 has the polarizing axis (transmission axis) parallel to the polarizing axis (transmission axis) of the linear polarization plate 40. In a case where the space phase modulator 1 is a reflection-type modulator, the space phase modulator 1 may further include a reflective mirror layer 60 that reflects the entering light L1, on the rear surface of the glass substrate 20, as illustrated in FIG. 7, for example. In the space phase modulator 1, an AR (Anti-Reflection) layer may be provided on a surface on side of the glass substrate 30, the AR layer preventing unwanted reflection of the entering light L1.

Next, a description is given of a tilt angle θt and the angle θth of the liquid crystal molecule 13a.

FIG. 8 illustrates an enlarged view of the liquid crystal molecule 13a. FIG. 8 exemplarily illustrates the liquid crystal molecule 13a when a fixed voltage (0V, for example) is applied to the common electrode 15 and an ON voltage (4V, for example) is applied to the pixel electrodes 11. The tilt angle θt refers to an angle made between the long axis of the liquid crystal molecule 13a and the XY plane (pixel electrode 11). The tile angle θt varies depending on a difference between the voltage applied to the pixel electrodes 11 and the voltage applied to the common electrode 15. The tilt angle θt when no voltage is applied to the pixel electrodes 11 and the common electrode 15 is referred to as the pretilt angle θt0.

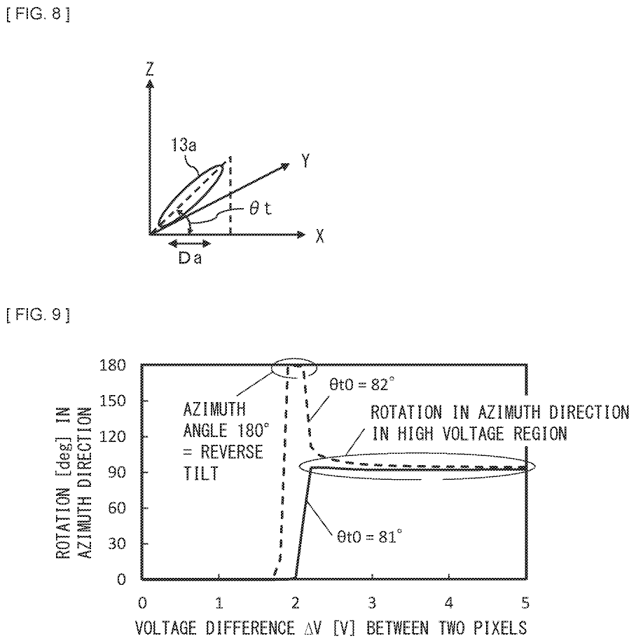

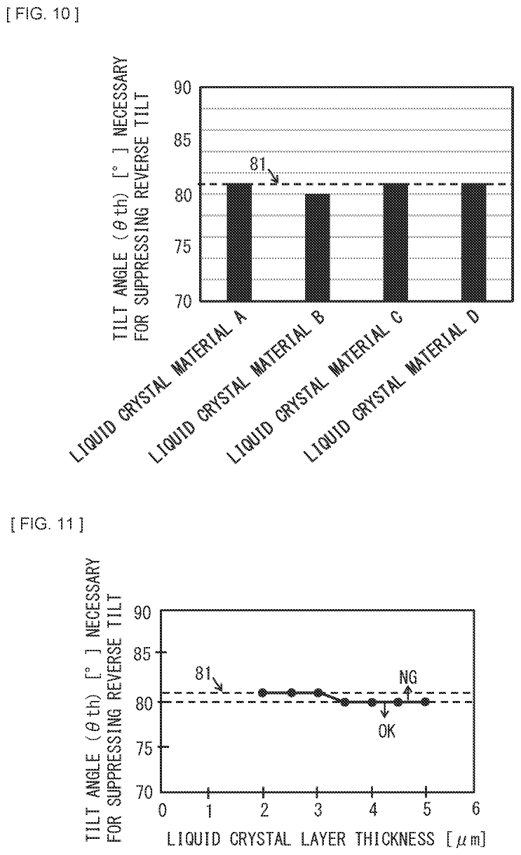

FIG. 9 illustrates an example of a relationship between the voltage difference ΔV between the two mutually adjacent pixel electrodes 11 and the rotation angle θa of the liquid crystal molecules 13a in the azimuth direction. It is to be noted that FIG. 9 illustrates experimental results when the liquid crystal molecules 13a were liquid crystal materials A of FIG. 10, and the liquid crystal layer 13 had a thickness of 3 μm. In a case where the voltage difference ΔV was changed from 0V to 5V after the pretilt angle θt0 was set to 81°, as illustrated in FIG. 9, the liquid crystal molecules 13a rotated in the azimuth direction in a high voltage region (2V to 5V) while no reverse tilt occurred in a low voltage region (0V to 2V). In contrast, in a case where the voltage difference ΔV was changed from 0V to 5V after the pretilt angle θt0 was set to 82°, as illustrated in FIG. 9, the liquid crystal molecules 13a rotated in the azimuth direction in the high voltage region after the reverse tilt occurred in the low voltage region. It is seen from this that no reverse tilt occurs in the liquid crystal molecules 13a in a case where the pretilt angle θt0 is set to 81° or less.

Incidentally, in a case where the reverse tilt occurs in adjacent pixels, even at an applied voltage that normally does not cause any rotation in the azimuth direction, rotation in the azimuth direction similar to the rotation in the azimuth direction in the high voltage region occurs due to propagation of the elastic force of liquid crystals. Therefore, by suppressing occurrence of the reverse tilt, it is possible to suppress the rotation in the azimuth direction that occurs around the reverse tilt. In addition, in a case where the pretilt angle θt0 of the liquid crystal molecules 13a is set smaller (that is, in a case where the liquid crystal molecules 13a are tilted), it becomes possible to suppress the reverse tilt because the effective anchoring force becomes stronger as the pretilt angle θt0 of the liquid crystal molecules 13a becomes smaller. Therefore, it is possible to completely suppress the rotation of the liquid crystal molecules 13a in the azimuth direction by setting the pretilt angle θt0 of the liquid crystal molecules 13a to the predetermined angle θth or less. That is, in FIG. 9, the angle θth refers to an upper limit value (81°) of the pretilt angle θt0 at which no reverse tilt occurs even when the voltage difference ΔV of the two mutually adjacent pixel electrodes 11 is changed from 0 volts to 5 volts (when the voltage difference ΔV is changed within a range of normal use).

FIG. 10 illustrates the angle θth when four types of generally available liquid crystal materials are used as the liquid crystal molecules 13a having the negative dielectric anisotropy. FIG. 10 illustrates experimental results when the liquid crystal layer 13 had the thickness of 3 μm. FIG. 11 illustrates an example of a relationship between the thickness of the liquid crystal layer 13 and the angle θth at which no reverse tilt occurs. FIG. 11 illustrates experimental results when the liquid crystal materials A of FIG. 10 were used. It is seen from FIG. 10 and FIG. 11 that the upper limit value (angle θth) of the pretilt angle θt0 is 80° at which no reverse tilt occurs regardless of the liquid crystal materials or the thickness of the liquid crystal layer.

From the foregoing, the alignment films 12 and 14 are configured to allow the pretilt angle θt0 of the liquid crystal molecules 13a to satisfy the following expression:

0°<θt0≤80°.

A lower limit value of the pretilt angle θt0 corresponds to a lower limit value that makes it possible to control a pretilt direction of the liquid crystal molecules 13a to be constant. It is to be noted that because no contrast ratio such as a light valve is necessary in phase modulation and it is sufficient to be able to identify a phase difference, it is not disadvantageous that the upper limit value of the pretilt angle θt0 is a value close to 90°.

### [Operations]

In the following, a description is given of operations of the space phase modulator 1.

### (Transmission Type)

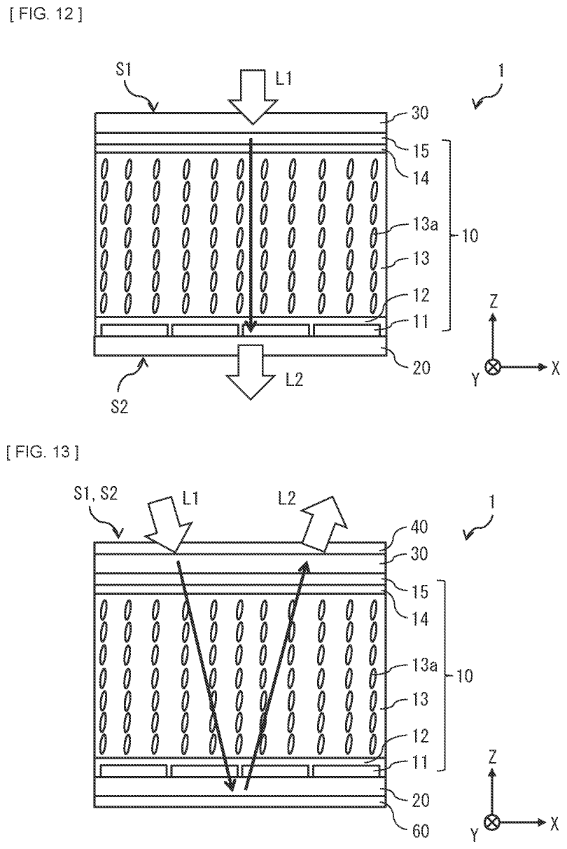

FIG. 12 illustrates an example of an operation when the space phase modulator 1 is the transmission-type modulator. A voltage set for each of the pixel electrodes 11 is applied to each of the pixel electrodes 11. Then, the tilt angle θt of the liquid crystal molecules 13a varies depending on the difference between the voltage applied to the pixel electrodes 11 and the voltage applied to the common electrode 15. In a case where the linear polarized light (entering light L1) having the polarization plane parallel to the alignment direction of the liquid crystal molecules 13a enters the surface (light entering surface S1) of the space phase modulator 1 on the side of the glass substrate 30, the entering light L1 is phase-modulated without rotating the polarization plane when passing through the liquid crystal layer 13. The phase-modulated light is outputted as outputted light L2 to outside from a surface (light outputting surface S2) on side of the glass substrate 20.

### (Reflection Type)

FIG. 13 illustrates an example of an operation when the space phase modulator 1 is the reflection-type modulator. The voltage set for each of the pixel electrodes 11 is applied to each of the pixel electrodes 11. Then, the tilt angle θt of the liquid crystal molecules 13a varies depending on the difference between the voltage applied to the pixel electrodes 11 and the voltage applied to the common electrode 15. The linear polarized light (entering light L1) having the polarization plane parallel to the alignment direction of the liquid crystal molecules 13a enters the surface (light entering surface S1) of the space phase modulator 1 on the side of the glass substrate 30. As illustrated in FIG. 13, for example, the entering light L1 may enter the light entering surface S1 obliquely or may enter the light entering surface S1 vertically. In a case where the entering light L1 enters the light entering surface S1, the entering light L1 passes through the liquid crystal layer 13, is reflected by a reflective mirror layer 60, and is outputted to the outside from the surface (light outputting surface S2) on the side of the glass substrate 30 after passing through the liquid crystal layer 13 again. At this time, the entering light L1 is phase-modulated without rotating the polarization plane, and the phase-modulated light is outputted to the outside as the outputted light L2.

### [Effects]

Next, a description is given of effects of the space phase modulator 1.

In the present embodiment, the alignment films 12 and 14 are configured to allow the pretilt angle θt of the liquid crystal molecules 13a to satisfy 0°<θt0≤80°. This suppresses the rotation of the liquid crystal molecules in the azimuth direction in the low voltage region. Therefore, it is possible to improve the utilization efficiency of light. In addition, in the high voltage region, because the rotation of the liquid crystal molecules to the azimuth direction triggered by the reverse tilt is suppressed, it is possible to improve the utilization efficiency of light.

### <2. Application Examples>

Next, a description is given of application examples of the space phase modulator 1 according to the above-described embodiment.

### [Application Example A]

FIG. 14 illustrates an example of a schematic configuration of a laser processing machine 100 including the space phase modulator 1. The laser processing machine 100 is an apparatus that forms a modified region on an object 200 by irradiating the object 200 with laser light La. The laser processing machine 100 includes a support section 110 supporting the object 200, a light source section 120, the space phase modulator 1, mirrors 130 and 140, an imaging optical system 150, and a light collecting section 160. In this application example, the space phase modulator 1 is the reflection-type modulator.

The support section 110 supports the object 200, for example, by adsorbing the object 200 so that a surface of the object 200 is parallel to the XY plane. The support section 110 is movable in each of an X direction and a Y direction and is rotatable in an XY surface.

The light source section 120 outputs laser light La with a pulse oscillation method, for example. The laser light La is linear polarized light. The light source section 120 outputs the laser light La so that a polarization plane of the laser light La is parallel to an alignment direction D1 of the liquid crystal molecules 13a when laser light La enters the space phase modulator 1 via the mirror 130 or the like.

The mirror 130 reflects the laser light La and causes the laser light La to enter the light entering surface S1 of the space phase modulator 1. The laser light La reflected by the mirror 130 enters the light entering surface S1 of the space phase modulator 1. In the space phase modulator 1, after passing through the liquid crystal layer 13, the laser light La is reflected by the reflective mirror layer 60. Reflected light (laser light Lb) passes through the liquid crystal layer 13 and is outputted to the outside. At this time, the laser light La is phase-modulated without rotating the polarization plane, and the phase-modulated light (laser light Lb) is outputted to the outside from the light entering surface S1 that also acts as the light outputting surface S2.

The mirror 140 reflects the laser light Lb and causes the laser light Lb to enter the light collecting section 160 via the imaging optical system 150. The imaging optical system 150 is a double-sided telecentric optical system in which a reflecting surface of the space phase modulator 1 and an entering pupil surface of the light collecting section 150 are in an imaging relationship. As a result, the laser light Lb modulated by the space phase modulator 1 is transferred (imaged) on the entering pupil surface of the light collecting section 150. By collecting and applying the laser light Lb onto the surface of the object 200, the light collecting section 150 causes an image captured on the entering pupil surface to be projected onto the surface of the object 200 at a predetermined scaling factor. As a result, the modified region of a pattern of the projected image is formed on the surface of the object 200.

In this application example, the space phase modulator 1 forms an image that is a basis of a pattern to be formed in the modified region. This makes it possible to realize the laser processing machine 100 with low power consumption.

### [Application Example B]

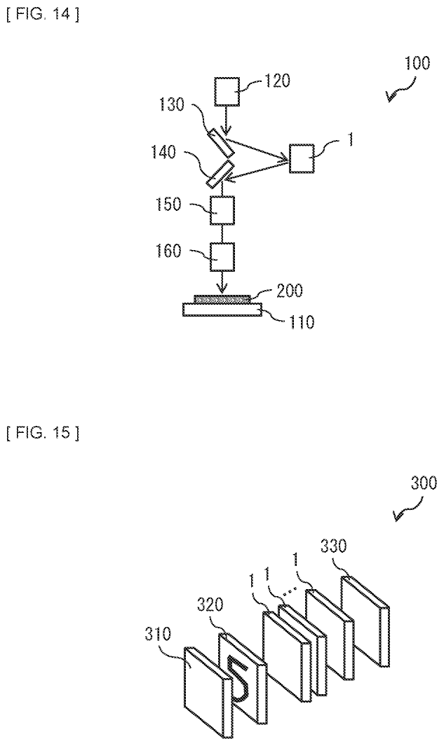

FIG. 15 illustrates an example of a schematic configuration of optical computing 300 including the space phase modulator 1. The optical computing 300 is an apparatus that decodes an image (for example, a digit) inputted to a light valve 320, and includes, for example, a light source section 310, the light valve 320, a plurality of the space phase modulators 1, and a detection section 330. In the optical computing 300, the plurality of space phase modulators 1 is stacked on each other with a predetermined gap in between.

The light source section 310 irradiates the light valve 320 with laser light. The light valve 320 is, for example, a light-transmission type optical modulator. The light valve 320 modulates light intensity of laser light that enters from the light source section 310 on the basis of a control signal (image data) inputted from the outside, thereby generating image light of a pattern corresponding to the control signal inputted from the outside. For example, the light valve 320 applies the generated image light to the first space phase modulator 1. The image light is phase-modulated by the first space phase modulator 1, and light obtained thereby is applied to the second space phase modulator 1. The light applied to the second space phase modulator 1 is phase-modulated by the second space phase modulator 1, and light obtained thereby is applied to the third space phase modulator 1. In this manner, the image light is phase-modulated by each of the space phase modulators 1, and light outputted from the last space phase modulator 1 is detected by the detection section 330. The detection section 330 estimates image data inputted to the light valve 320 on the basis of the inputted light.

It is to be noted that in this application example, the light source section 310 and the light valve 320 may be omitted, so that the image light inputted from the outside is applied to the first space phase modulator 1. In addition, in this application example, the light source section 310 and the light valve 320 may be omitted, so that a paper surface on which characters or pictures or the like are drawn is disposed on the light entering surface of the first space phase modulator 1 and causes the first space phase modulator 1 to detect external light that passes through the paper surface.

In this application example, the space phase modulator 1 forms a phase distribution that determines content of processing in the optical computing 300. This makes it possible to realize the optical computing 300 with low power consumption and ability to change calculation content.

### [Application Example C]

The technology according to the present disclosure is applicable to a variety of products. For example, the technology according to the present disclosure may be achieved as a device mounted on any type of mobile body such as a vehicle, an electric vehicle, a hybrid electric vehicle, a motorcycle, a bicycle, a personal mobility, an airplane, a drone, a vessel, a robot, a construction machine, or an agricultural machine (tractor).

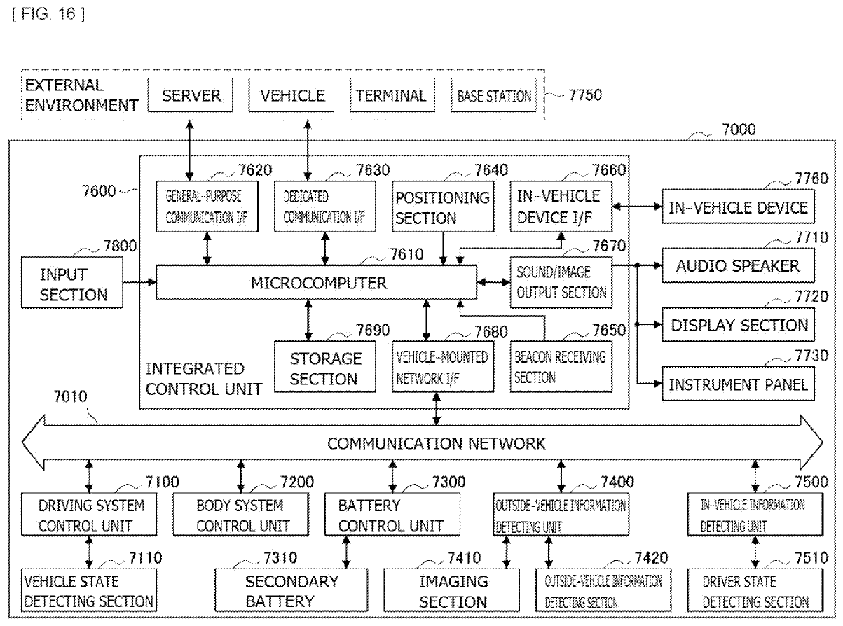

FIG. 16 is a block diagram depicting an example of schematic configuration of a vehicle control system 7000 as an example of a mobile body control system to which the technology according to an embodiment of the present disclosure can be applied. The vehicle control system 7000 includes a plurality of electronic control units connected to each other via a communication network 7010. In the example depicted in FIG. 16, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay (registered trademark), or the like.

Each of the control units includes: a microcomputer that performs arithmetic processing according to various kinds of programs; a storage section that stores the programs executed by the microcomputer, parameters used for various kinds of operations, or the like; and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. A functional configuration of the integrated control unit 7600 illustrated in FIG. 16 includes a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690. The other control units similarly include a microcomputer, a communication I/F, a storage section, and the like.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like from a battery device including the secondary battery 7310. The battery control unit 7300 performs arithmetic processing using these signals, and performs control for regulating the temperature of the secondary battery 7310 or controls a cooling device provided to the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight (ToF) camera, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device). Each of the imaging section 7410 and the outside-vehicle information detecting section 7420 may be provided as an independent sensor or device, or may be provided as a device in which a plurality of sensors or devices are integrated.

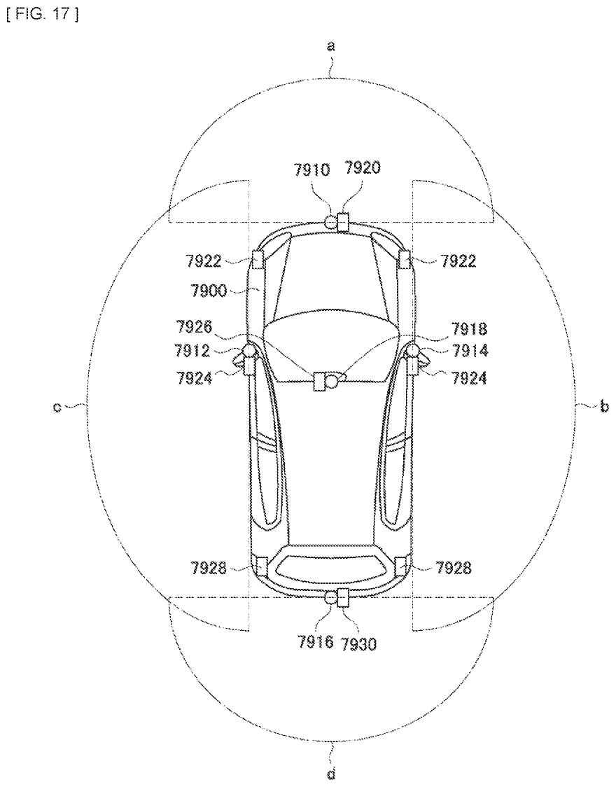

FIG. 17 depicts an example of installation positions of the imaging section 7410 and the outside-vehicle information detecting section 7420. Imaging sections 7910, 7912, 7914, 7916, and 7918 are, for example, disposed at at least one of positions on a front nose, sideview mirrors, a rear bumper, and a back door of the vehicle 7900 and a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided to the sideview mirrors obtain mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Incidentally, FIG. 17 depicts an example of photographing ranges of the respective imaging sections 7910, 7912, 7914, and 7916. An imaging range a represents the imaging range of the imaging section 7910 provided to the front nose. Imaging ranges b and c respectively represent the imaging ranges of the imaging sections 7912 and 7914 provided to the sideview mirrors. An imaging range d represents the imaging range of the imaging section 7916 provided to the rear bumper or the back door. A bird's-eye image of the vehicle 7900 as viewed from above can be obtained by superimposing image data imaged by the imaging sections 7910, 7912, 7914, and 7916, for example.

Outside-vehicle information detecting sections 7920, 7922, 7924, 7926, 7928, and 7930 provided to the front, rear, sides, and corners of the vehicle 7900 and the upper portion of the windshield within the interior of the vehicle may be, for example, an ultrasonic sensor or a radar device. The outside-vehicle information detecting sections 7920, 7926, and 7930 provided to the front nose of the vehicle 7900, the rear bumper, the back door of the vehicle 7900, and the upper portion of the windshield within the interior of the vehicle may be a LIDAR device, for example. These outside-vehicle information detecting sections 7920 to 7930 are used mainly to detect a preceding vehicle, a pedestrian, an obstacle, or the like.

Returning to FIG. 16, the description will be continued. The outside-vehicle information detecting unit 7400 makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information of a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

In addition, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may subject the received image data to processing such as distortion correction, alignment, or the like, and combine the image data imaged by a plurality of different imaging sections 7410 to generate a bird's-eye image or a panoramic image. The outside-vehicle information detecting unit 7400 may perform viewpoint conversion processing using the image data imaged by the imaging section 7410 including the different imaging parts.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that images the driver, a biosensor that detects biological information of the driver, a microphone that collects sound within the interior of the vehicle, or the like. The biosensor is, for example, disposed in a seat surface, the steering wheel, or the like, and detects biological information of an occupant sitting in a seat or the driver holding the steering wheel. On the basis of detection information input from the driver state detecting section 7510, the in-vehicle information detecting unit 7500 may calculate a degree of fatigue of the driver or a degree of concentration of the driver, or may determine whether the driver is dozing. The in-vehicle information detecting unit 7500 may subject an audio signal obtained by the collection of the sound to processing such as noise canceling processing or the like.

The integrated control unit 7600 controls general operation within the vehicle control system 7000 in accordance with various kinds of programs. The integrated control unit 7600 is connected with an input section 7800. The input section 7800 is implemented by a device capable of input operation by an occupant, such, for example, as a touch panel, a button, a microphone, a switch, a lever, or the like. The integrated control unit 7600 may be supplied with data obtained by voice recognition of voice input through the microphone. The input section 7800 may, for example, be a remote control device using infrared rays or other radio waves, or an external connecting device such as a mobile telephone, a personal digital assistant (PDA), or the like that supports operation of the vehicle control system 7000. The input section 7800 may be, for example, a camera. In that case, an occupant can input information by gesture. Alternatively, data may be input which is obtained by detecting the movement of a wearable device that an occupant wears. Further, the input section 7800 may, for example, include an input control circuit or the like that generates an input signal on the basis of information input by an occupant or the like using the above-described input section 7800, and which outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various kinds of programs executed by the microcomputer and a random access memory (RAM) that stores various kinds of parameters, operation results, sensor values, or the like. In addition, the storage section 7690 may be implemented by a magnetic storage device such as a hard disc drive (HDD) or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM (registered trademark)), worldwide interoperability for microwave access (WiMAX (registered trademark)), long term evolution (LTE (registered trademark)), LTE-advanced (LTE-A), or the like, or another wireless communication protocol such as wireless LAN (referred to also as wireless fidelity (Wi-Fi (registered trademark)), Bluetooth (registered trademark), or the like. The general-purpose communication I/F 7620 may, for example, connect to an apparatus (for example, an application server or a control server) present on an external network (for example, the Internet, a cloud network, or a company-specific network) via a base station or an access point. In addition, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a road and a vehicle (Vehicle to Infrastructure), communication between a vehicle and a home (Vehicle to Home), and communication between a pedestrian and a vehicle (Vehicle to Pedestrian).

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like. Incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present within the vehicle. The in-vehicle device I/F 7660 may establish wireless connection using a wireless communication protocol such as wireless LAN, Bluetooth (registered trademark), near field communication (NFC), or wireless universal serial bus (WUSB). In addition, the in-vehicle device I/F 7660 may establish wired connection by universal serial bus (USB), high-definition multimedia interface (HDMI (registered trademark)), mobile high-definition link (MHL), or the like via a connection terminal (and a cable if necessary) not depicted in the figures. The in-vehicle devices 7760 may, for example, include at least one of a mobile device and a wearable device possessed by an occupant and an information device carried into or attached to the vehicle. The in-vehicle devices 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automated driving, which makes the vehicle to travel automatedly without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. In addition, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound and an image to an output device capable of visually or auditorily notifying information to an occupant of the vehicle or the outside of the vehicle. In the example of FIG. 16, an audio speaker 7710, a display section 7720, and an instrument panel 7730 are illustrated as the output device. The display section 7720 may, for example, include at least one of an on-board display and a head-up display. The display section 7720 may have an augmented reality (AR) display function. The output device may be other than these devices, and may be another device such as headphones, a wearable device such as an eyeglass type display worn by an occupant or the like, a projector, a lamp, or the like. In a case where the output device is a display device, the display device visually displays results obtained by various kinds of processing performed by the microcomputer 7610 or information received from another control unit in various forms such as text, an image, a table, a graph, or the like. In addition, in a case where the output device is an audio output device, the audio output device converts an audio signal constituted of reproduced audio data or sound data or the like into an analog signal, and auditorily outputs the analog signal.

Incidentally, at least two control units connected to each other via the communication network 7010 in the example depicted in FIG. 16 may be integrated into one control unit. Alternatively, each individual control unit may include a plurality of control units. Further, the vehicle control system 7000 may include another control unit not depicted in the figures. In addition, part or the whole of the functions performed by one of the control units in the above description may be assigned to another control unit. That is, predetermined arithmetic processing may be performed by any of the control units as long as information is transmitted and received via the communication network 7010. Similarly, a sensor or a device connected to one of the control units may be connected to another control unit, and a plurality of control units may mutually transmit and receive detection information via the communication network 7010.

It is to be noted that it is possible to mount a computer program for realizing each function of the space phase modulator 1 described with reference to FIGS. 1 to 13 and the like on any control unit or the like. In addition, it is also possible to provide a computer-readable recording medium in which such a computer program is stored. The recording medium is, for example, a magnetic disk, an optical disk, a magneto-optical disk, a flash memory, or the like. In addition, the computer program described above may be distributed through a network, for example, without using a recording medium.

In the vehicle control system 7000 described above, it is possible to use the space phase modulator 1 described with reference to FIG. 1 to FIG. 13, or the like, as a light source steering section of LIDAR as an environment sensor, for example. In addition, an optical computing unit that uses the space phase modulator 1 as described with reference to FIG. 1 to FIG. 13, or the like, is able to perform image recognition in the imaging section. In a case where the space phase modulator 1 as described with reference to FIG. 1 to FIG. 13, or the like, is used as a highly efficient/high intensity projection device, it is possible to project lines or characters on the ground. Specifically, it is possible to display a line so that people outside a car are able to see where the car is passing when backing up, or to display crosswalks with light when the car gives way to pedestrians.

Moreover, at least some components of the space phase modulator 1 as described with reference to FIG. 1 to FIG. 13, or the like, may be realized in a module (such as an integrated circuit module including one die) for the integrated control unit 7600 illustrated in FIG. 16. Alternatively, the space phase modulator 1 as described with reference to FIG. 1 to FIG. 13, or the like, may be implemented by the plurality of control units of the vehicle control system 7000 illustrated in FIG. 16.

As described above, the present disclosure has been described with the embodiments and the application examples of the embodiments. However, the present disclosure is not to be limited to the above-described embodiments, or the like, and various modifications are possible. It is to be noted that effects described herein are not necessarily limited to the effects described herein. The present disclosure may have any effect other than those described in the present disclosure.

In addition, the present disclosure may have, for example, the following configurations:

(1)

A space phase modulator that modulates a phase of light to generate a desired image, the space phase modulator including:
a stacked body in which a plurality of pixel electrodes, a first alignment film, a liquid crystal layer, a second alignment film, and a common electrode are stacked in this order, in which
the liquid crystal layer includes liquid crystal molecules having a negative dielectric anisotropy, and
the first alignment film and the second alignment film are configured to allow a pretilt angle θt0 of the liquid crystal molecules to satisfy 0°<θt0≤80°.
   (2)

A processing apparatus that uses a space phase modulator, the space phase modulator modulating a phase of light to generate a desired image, in which
the space phase modulator includes a stacked body in which a plurality of pixel electrodes, a first alignment film, a liquid crystal layer, a second alignment film, and a common electrode are stacked in this order,
the liquid crystal layer includes liquid crystal molecules having a negative dielectric anisotropy, and
the first alignment film and the second alignment film are configured to allow a pretilt angle θt0 of the liquid crystal molecules to satisfy 0°<θt0≤80°.
   (3)

An information processor that uses one or more space phase modulators, the one or more space phase modulators each modulating a phase of light to generate a desired image, in which
the one or more space phase modulators each include a stacked body in which a plurality of pixel electrodes, a first alignment film, a liquid crystal layer, a second alignment film, and a common electrode are stacked in this order,
the liquid crystal layer includes liquid crystal molecules having a negative dielectric anisotropy, and
the first alignment film and the second alignment film are configured to allow a pretilt angle θt0 of the liquid crystal molecules to satisfy 0°<θt0≤80°.

In the space phase modulator, the processing apparatus, and the information processor according to the respective embodiments of the present disclosure, the first alignment film and the second alignment film are configured to allow a pretilt angle θt0 of the liquid crystal molecules to satisfy 0°<θt0≤80°. This suppresses rotation of the liquid crystal molecules in the azimuth direction, which makes it possible to improve the utilization efficiency of light. It is to be noted that the effects of the present disclosure are not necessarily limited to those described above, and may be any of the effects described herein.

This application claims priority based on Japanese Patent Application No. 2021-123676 filed on Jul. 28, 2021 with Japan Patent Office, the entire contents of which are incorporated in this application by reference.

It should be understood by those skilled in the art that various modifications, combinations, sub-combinations and alterations may occur depending on design requirements and other factors insofar as they are within the scope of the appended claims or the equivalents thereof.

1. A space phase modulator that modulates a phase of light to generate a desired image, the space phase modulator comprising:
a stacked body in which a plurality of pixel electrodes, a first alignment film, a liquid crystal layer, a second alignment film, and a common electrode are stacked in this order, wherein
the liquid crystal layer includes liquid crystal molecules having a negative dielectric anisotropy, and
the first alignment film and the second alignment film are configured to allow a pretilt angle θt0 of the liquid crystal molecules to satisfy 0°<θt0≤80°.

2. A processing apparatus that uses a space phase modulator, the space phase modulator modulating a phase of light to generate a desired image, wherein
the space phase modulator includes a stacked body in which a plurality of pixel electrodes, a first alignment film, a liquid crystal layer, a second alignment film, and a common electrode are stacked in this order,
the liquid crystal layer includes liquid crystal molecules having a negative dielectric anisotropy, and
the first alignment film and the second alignment film are configured to allow a pretilt angle θt0 of the liquid crystal molecules to satisfy 0°<θt0≤80°.

3. An information processor that uses one or more space phase modulators, the one or more space phase modulators each modulating a phase of light to generate a desired image, wherein
the one or more space phase modulators each include a stacked body in which a plurality of pixel electrodes, a first alignment film, a liquid crystal layer, a second alignment film, and a common electrode are stacked in this order,
the liquid crystal layer includes liquid crystal molecules having a negative dielectric anisotropy, and
the first alignment film and the second alignment film are configured to allow a pretilt angle θt0 of the liquid crystal molecules to satisfy 0°<θt0≤80°.
